(19) United States
(12) Patent Application Publication
(10) Pub. No.: US 2026/0061619 A1
(43) Pub. Date: Mar. 5, 2026

(54) HUMAN-ASSISTED SUPERVISED AUTONOMOUS MOBILE ROBOT SYSTEM

(71) Applicant: FACTION TECHNOLOGY, INC., South San Francisco, CA (US)

(72) Inventors: Ain MCKENDRICK, Redwood City, CA (US); Andrea MARIOTTI, Pacifica, CA (US); Nick KAESHKO, South San Francisco, CA (US)

(21) Appl. No.: 19/316,857

(22) Filed: Sep. 2, 2025

Related U.S. Application Data
(60) Provisional application No. 63/689,495, filed on Aug. 30, 2024.

(51) Int. Cl. B25J 9/16

(52) U.S. Cl. CPC B25J 9/1689; B25J 9/162; B25J 9/1658; B25J 9/1664

(57) ABSTRACT

An example method to control an autonomous mobile robot includes accessing an assist scenario database, the assist scenario database comprising a large language model(s) related to driving operations and scenarios. The method further includes receiving an autonomous input from the assist scenario database comprising a suggested vehicle trajectory or instruction. The method further includes receiving teleoperator input to authorize or modify the assist scenario database instruction. The method further includes outputting a trajectory signal based on the teleoperator input. The method further includes the autonomous mobile robot executing the trajectory signal or components.

### CROSS-REFERENCE TO RELATED APPLICATION

This application claims the benefit of and priority to U.S. Provisional App. No. 63/689,495 filed Aug. 30, 2024 which is incorporated herein by reference in its entirety.

### FIELD

The present disclosure is generally related to a human-assisted supervised autonomous mobile robot system.

### BACKGROUND

Unless otherwise indicated herein, the materials described herein are not prior art to the claims in the present application and are not admitted to be prior art by inclusion in this section.

Autonomous vehicles are designed to be operated without input from a human operator. Even with the assistance of input from a human operator, autonomous driving systems presently do not make use of learning models that are scalable based on the input from the human operator.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

In an embodiment, a method to control an autonomous mobile robot system includes receiving autonomous input for an autonomous mobile robot from an assist scenario database. The autonomous input includes one or both of a suggested trajectory or a suggested behavior. The method includes receiving teleoperator input that includes one or both of a suggested trajectory adjustment or a suggested behavior authorization. The method includes outputting a trajectory signal that depends on both the autonomous input and the teleoperator input. The trajectory signal includes one or both of an updated trajectory or an authorized behavior. The method includes storing one or more of the autonomous input, the teleoperator input, the suggested trajectory adjustment, the suggested behavior authorization, or the trajectory signal in the assist scenario database.

In another embodiment, a non-transitory computer-readable storage medium includes computer-readable instructions executable by a processor to perform or control performance of operations. The operations include receiving autonomous input for an autonomous mobile robot from an assist scenario database. The autonomous input includes one or both of a suggested trajectory or a suggested behavior. The operations include receiving teleoperator input that includes one or both of a suggested trajectory adjustment or a suggested behavior authorization. The operations include outputting a trajectory signal that depends on both the autonomous input and the teleoperator input. The trajectory signal includes one or both of an updated trajectory or an authorized behavior. The method includes storing one or more of the autonomous input, the teleoperator input, the suggested trajectory adjustment, the suggested behavior authorization, or the trajectory signal in the assist scenario database.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF DESCRIPTION OF THE DRAWINGS

Example embodiments will be described and explained with additional specificity and detail through the use of the accompanying drawings in which:

FIG. 1A illustrates an example autonomous mobile robot system;

FIGS. 1B-1C include screen shots of an example teleoperator interface depicting a planned trajectory for a teleoperator of FIG. 1A;

FIG. 2A illustrates an example autonomous mobile robot system with an assist scenario database;

FIG. 2B includes a screen shot of an example teleoperator interface depicting a trajectory chosen or suggested by a CTM or assist scenario database for a teleoperator of FIG. 2A;

FIG. 3A illustrates an example operating environment for an autonomous mobile robot system;

FIG. 3B illustrates various example mobile robots that may be implemented in, e.g., the operating environment of FIG. 3A;

FIG. 4 illustrates an example operating environment for an autonomous mobile robot system with an assist scenario database;

FIG. 5 is a flowchart of an example method of an autonomous mobile robot system with an assist scenario database;

FIG. 6 illustrates a block diagram of an example computing system;

FIG. 7 is a flowchart of an example method of an autonomous mobile robot system; and

FIG. 8 is a flowchart of another example method of an autonomous mobile robot system utilizing an assist scenario database.

### DESCRIPTION OF EMBODIMENTS

Vehicles may be used for a variety of purposes, including the transportation of persons and/or cargo. Recent developments in technology have begun to enable driverless vehicles, such as autonomous vehicles. Various embodiments herein are discussed in the context of autonomous vehicles but embodiments described herein may be implemented more generally in or with autonomous mobile robots, examples of which include autonomous vehicles.

Some autonomous vehicles (and/or other mobile robots) are designed to operate independent of human input. For example, an autonomous vehicle may be capable of accelerating, braking, turning, obeying traffic laws, etc., all without input from a teleoperator. In the present disclosure, a teleoperator refers to a remote human operator of an autonomous vehicle (or other mobile robot) who is able to (remotely) provide operational input to the autonomous vehicle using remote controls.

For autonomous systems to have control over an autonomous vehicle, electromechanical systems, such as drive by wire, may be implemented in the autonomous vehicle. The electromechanical systems may be systems that use electrical signals in lieu of systems that have previously been mechanical systems. For example, in a drive by wire system, a steering wheel may be replaced such that electrical signals may dictate the control of the steering system and may be termed steer by wire. Alternatively, and/or additionally, a gas pedal may be replaced by electric throttle controls and may be termed throttle by wire. Alternatively, and/or additionally, a brake pedal may be replaced by electronic braking controls and may be termed brake by wire. The various electromechanical systems including steer by wire, throttle by wire, and brake by wire, may be summarized by the term drive by wire, where an autonomous vehicle using drive by wire may implement some or all of the underlying electromechanical systems.

Autonomous vehicles may use artificial intelligence (AI) technology as part of an autonomy system to determine and implement a driving strategy in relation to the autonomous vehicle. A driving strategy may include maintaining safe distances from other vehicles and objects, following posted speed limits, maintaining a position in a lane, safely changing lanes when needed, etc. For example, the autonomy system may determine that a speed limit sign indicates a slower maximum speed and the autonomy system may direct the autonomous vehicle to slow down by reducing the amount of applied throttle and/or by braking.

In some circumstances, AI technology may be trained to make decisions regarding the autonomous vehicle's operation through machine learning. Machine learning may include analyzing various scenarios that an autonomous vehicle may encounter while driving. In some circumstances, AI technology may be trained using thousands or millions of scenarios in an attempt to learn appropriate responses to a given situation. For example, AI technology in an autonomy system may learn to rapidly apply the brakes of an autonomous vehicle when brake lights are detected on a vehicle directly in front of the autonomous vehicle.

One common problem with autonomous vehicles and with autonomy systems' control thereof, is the difficulty of including every possible permutation of scenarios that may be encountered while driving. As such, there may be instances in which the autonomy system may be unable to determine a course of action. In some circumstances, when confronted with a new or unexpected scenario, an autonomy system may determine to pull over and stop, or more drastically, to immediately stop in the lane. Immediately stopping in lane, or even pulling over and stopping, may introduce additional hazards to the autonomous vehicle, its passengers, and/or cargo therein. For example, immediately stopping may increase the chances of being rear-ended by another automobile following the autonomous vehicle. As another example, pulling over and stopping may occur in a hazardous location, such as a narrow shoulder on an interstate, or a shoulder that contains debris prone to puncture tires.

A solution to bridge the gap between pure autonomous vehicles using an autonomy system (where “pure” autonomy may indicate a fully operational autonomous vehicle in all circumstances, without any human input) and the problems associated with unpredictable driving scenarios is to implement teleoperation functionality in the autonomous vehicle system. Teleoperation functionality allows a teleoperator to provide input to the autonomous vehicle. Navigation scenarios that might be difficult to handle autonomously may be a relatively simple procedure for a teleoperator to maneuver.

In some circumstances, teleoperations between a teleoperator and an autonomous vehicle may be configured to be transmitted over a network. The network may include the Internet, one or more cellular radio frequency (RF) networks, and/or one or more wired and/or wireless networks.

In some circumstances, teleoperations may introduce human oversight and/or control into the autonomous vehicle system which may aid in circumventing potential issues in which an autonomy system may not be equipped to handle. In some circumstances, teleoperations may provide a video feed from the autonomous vehicle which may enable remote operation of an autonomous vehicle. For example, a teleoperator may be able to assume direct control of an autonomous vehicle even if located remotely.

A first mode of teleoperations may be direct teleoperation. Under direct teleoperation, a teleoperator may remotely provide all the controls to an autonomous vehicle. For example, a teleoperator may provide remote inputs that control the steering, acceleration, and braking of an autonomous vehicle. In some circumstances, direct teleoperation may be a fast method of teleoperations to deploy as teleoperators are generally experienced at handling unexpected scenarios while driving. Alternatively, and/or additionally, some maneuvers and/or scenarios an autonomous vehicle may encounter may be exceptionally difficult to resolve using an autonomy system, but those maneuvers and/or scenarios may be easily handled by a teleoperator controlling the autonomous vehicle under direct teleoperation.

However, direct teleoperation may require the teleoperator to have a high level of training and/or proficiency in remote vehicle operations. For example, fully controlling an autonomous vehicle via remote control using video feeds and drive by wire technology may be substantially different than operating an automobile in the driver's seat and may require substantial training to become proficient. Alternatively, and/or additionally, the teleoperator may encounter delays in the video feed and controls due to latency in the network, which may be mitigated by additional training and/or limiting direct teleoperations of the autonomous vehicle to low speed environments. Alternatively, and/or additionally, direct teleoperations may introduce a heavy cognitive strain on a teleoperator as the teleoperator must maintain a heightened focus on the task of remote operation.

A second mode of teleoperations may be supervised teleoperation. Supervised teleoperation may permit a teleoperator to handle high-level decisions related to operating an autonomous vehicle, while an autonomy system may govern more simple, predefined operations. For example, an autonomous vehicle travelling on a highway under supervised teleoperation may use the autonomy system to maintain its position in lane, but the autonomy system may not change lanes unless directed by a teleoperator. Supervised teleoperation may include a smaller teleoperator workload compared to direct teleoperation as teleoperator input is only required in decision making, as opposed to complete control of the autonomous vehicle under direct teleoperation. Alternatively, and/or additionally, the autonomy system of the autonomous vehicle under supervised teleoperation may continue to implement collision avoidance as a safety measure for the teleoperators'decisions.

In some circumstances, the predefined operations under supervised teleoperation may be limited to relatively simple maneuvers by an autonomous vehicle. For example, predefined operations may include throttle control, brake control, steering controls to maintain lane-keeping, distance between other vehicles, etc. Alternatively, and/or additionally, supervised teleoperation may be an inadequate method of control over an autonomous vehicle when the environment becomes more dynamic or difficult to maneuver. In instances in which the environment becomes too complex for supervised teleoperation, the autonomous vehicle may revert to direct teleoperation, as discussed above. For example, supervised teleoperation may be unsuitable for an autonomous vehicle entering a city environment or a parking lot and the autonomous vehicle may transition to direct teleoperations, requiring a teleoperator to remotely control the autonomous vehicle.

In some circumstances, direct teleoperation and supervised teleoperation may be modal in application. For example, in instances in which direct teleoperation are implemented, supervised teleoperation may be inoperative. Additionally, in instances in which an autonomous vehicle is operating under supervised teleoperations, direct teleoperation may be disabled.

A third mode of teleoperations may be cooperative teleoperation. In some embodiments, cooperative teleoperation may employ an autonomy system to maneuver an autonomous vehicle while accepting input from a teleoperator as part of the planning and control of the movement of the autonomous vehicle. For example, an autonomous vehicle's autonomy system may determine a first path to navigate a portion of roadway. With the autonomy system still functioning, a teleoperator may make an “on the fly” adjustment to the movement and trajectory of the autonomous vehicle. In some embodiments, the autonomy system may update the determined path in response to the input from the teleoperator.

In some embodiments, cooperative teleoperation may enable the autonomy system to continually operate while the autonomous vehicle is in motion. For example, the autonomy system may not disengage when a teleoperator provides input or control over the autonomous vehicle. In some embodiments, the autonomy system of an autonomous vehicle in cooperative teleoperations may automatically recalculate the autonomous vehicle's trajectory in response to receiving input from a teleoperator. Alternatively, and/or additionally, the autonomy system may receive and implement additional input from the teleoperator and further refine the planned trajectory of the autonomous vehicle.

In other embodiments, cooperative teleoperation may include a cooperative teleoperation module that implements a large language model (LLM) artificial intelligence (AI) system, also called an assist scenario database, which results in a human-assisted, supervised autonomous driving system that includes an action recommendation engine powered by the assist scenario database. An LLM is a type of artificial intelligence (AI) algorithm that uses deep learning techniques and massively large data sets to understand, summarize, generate and predict responses to queries. In some embodiments, the assist scenario database is also a Generative Pre-trained Transformer (GPT) database, which may include a family of LLMs.

A primary advantage of a LLM AI system is that it continuously learns by receiving and storing data from each use case and scenario; thus, the LLM forms an ever-growing foundation for customized use cases, where additional training data collected by the LLM creates a finely-tuned model capable of creatively responding to new and unexpected, specific needs. Thus, in one embodiment, an autonomous driving vehicle involves an assist scenario database utilizing LLM to gather and store past examples of driving scenarios, which causes the autonomous driving vehicle to be able to recognize, interpret, and respond to future various driving scenarios. Therefore, example embodiments, where the autonomous driving is performed via an assist scenario database based on GPT and/or LLM(s) supervised by knowledge learned from human teleoperators, pose many advantages over the prior art, as the prior art is highly dependent on matching similar sensor data (e.g., LIDAR), and requires retraining the entire data-set if sensors are moved; but, for embodiments as described herein, GPT/LLMs eliminate the need to retrain an entire data-set if variables, such as sensor location and/or vehicle size, have changed. The present embodiments, therefore, are greatly preferred over the rigid machine learning models of the prior art.

In some embodiments, the LLM including the assist scenario database includes essentially a collection of objects and actions: examples of objects include a road blockage, traffic lights, limit lines, and other fixed items in the driving environment, and examples of actions include course line adjustments, speed control, and authorizations to move. The combination of an object and an action being fed into the assist scenario database LLM allows it to learn the object-action relationship, to then be able to present a suggested scenario in a future complex driving scenario.

In some embodiments, remote human teleoperators may provide an instruction to an autonomous vehicle, where an assist scenario database will store the human teleoperators' instruction for future reference by the autonomous vehicle. In other embodiments, the autonomous vehicle's autonomy system may choose a trajectory or course of action, and a human teleoperator may validate or approve the trajectory or course of action chosen, and the assist scenario database may remember the chosen trajectory or course, and remember that it was approved by the human teleoperator. In this manner, the autonomy system utilizes LLM to learn and scale, and predict its own response and course of action to complex, unexpected driving scenarios. The actions, instructions, choices, and/or validations of the human teleoperator may be fed back into the assist scenario database, such that its knowledge and performance are improved over time. Thereby, a cooperative AI training loop may develop an assist scenario database into a fully autonomous driving agent, where the assist scenario database is continuously learning and improving from the input of human teleoperators, and the workload of the human teleoperators is reduced as the assist scenario database improves.

Thus, in some embodiments, based on collected observational and empirical data gathered and stored in the assist scenario database, the assist scenario database constructs a comprehensive database of driving trajectories and the corresponding teleoperator actions, for improving and executing the autonomous driving vehicle system. In some embodiments, when a driverless vehicle encounters a complex driving situation, the cooperative teleoperation module consults the assist scenario database and suggests a trajectory and vehicle actions for the remote teleoperator to choose from. The cooperative teleoperation module then awaits confirmation of the suggested trajectory, or a modification of the suggested trajectory, by the human teleoperator as input to refine scenarios. This process enhances the decision-making capability of the teleoperator by providing them with data-backed suggestions in real-time, but offers the safety of not allowing an AI agent to make a final decision.

Therefore, in some embodiments, as the teleoperator selects and executes actions from the suggestions of the assist scenario database, the assist scenario database LLM model uses positive reinforcement learning to refine its understanding of various driving scenarios. This ongoing learning process ensures that the cooperative teleoperation module system remains up-to-date and increasingly effective in assisting teleoperators in managing driverless vehicles. The assist scenario database also reduces the cognitive workload on teleoperators by itself first suggesting actions and scenarios, which allows teleoperators to focus on higher-level tasks, maintain performance over extended shifts, oversee a larger amount of driverless vehicles, and therefore increase efficiency and reduce overall costs. In other embodiments, after the assist scenario database has received authorization for certain actions performed by the driverless vehicle in particular scenarios at a statistically significant threshold, the authorized actions may then propagate to the vehicle from the assist scenario database and execute unsupervised, i.e., without need for teleoperator authorization or approval.

In some embodiments, the cooperative teleoperation module may utilize even more than one assist scenario database and combinations of assist scenario databases, i.e., combinations of LLMs or discrete LLMs, such as a driving intersection LLM, a traffic light LLM, an overtake LLM, a free space LLM, and/or combinations thereof. Furthermore, in some embodiments, not only is the assist scenario database created and/or improved by collecting real-time driving data, the assist scenario database may also be initially generated by receiving one or more cloud-based LLMs. In some embodiments, the assist scenario database runs entirely in the cloud, and not on the vehicle, which may serve to save power on the vehicle. In other embodiments, authorized actions performed by the driverless vehicle in particular scenarios may propagate from the cloud-based assist scenario database to the vehicle and execute unsupervised. Cloud-based architecture may result in low-cost vehicle hardware, thereby reducing overall vehicle costs.

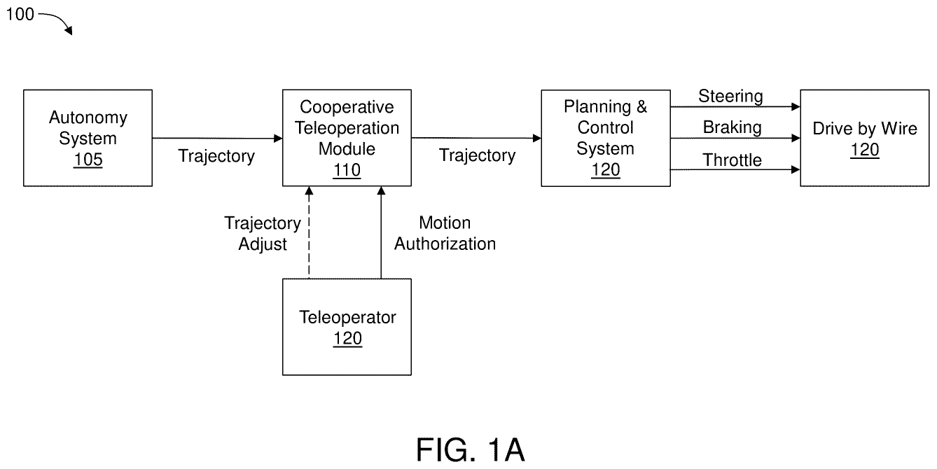

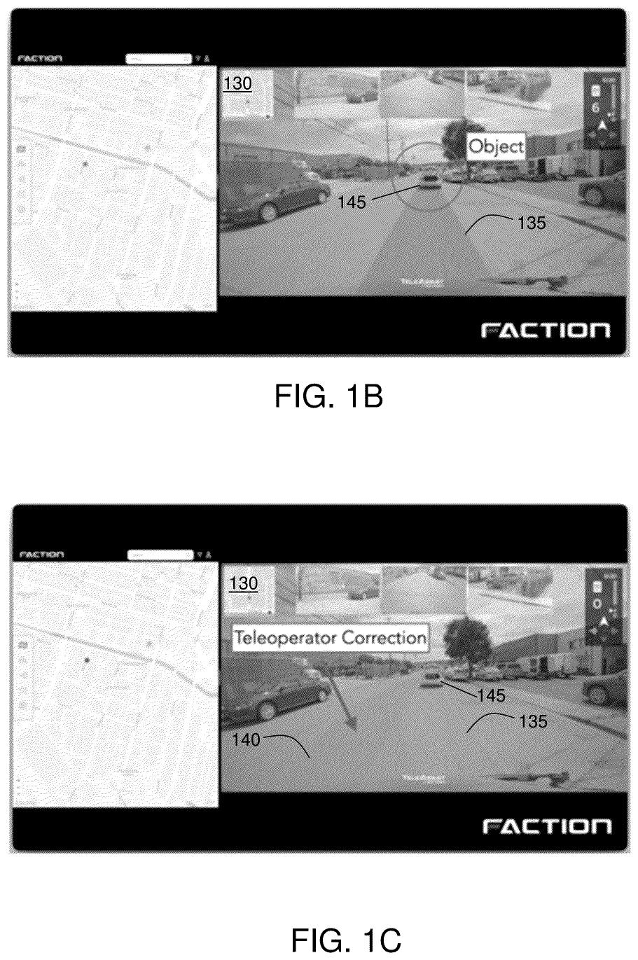

FIG. 1A illustrates an example autonomous mobile robot system 100, in accordance with at least one embodiment of the present disclosure. The autonomous mobile robot system 100 may typically include an autonomy system 105, a planning and control system 120, a cooperative teleoperation module 110, a human teleoperator 115, and a drive (or control) by wire system 125. In some embodiments, an output of the autonomy system 105 may include a planned trajectory. The planned trajectory may include an initial route for an autonomous mobile robot to traverse without additional input from another system or a human operator or teleoperator. In the discussion that follows, the autonomous mobile robot is described as an autonomous vehicle, such that the autonomous mobile robot system 100 may described as an autonomous vehicle system 100 or autonomous driving system 100, but may more generally include an autonomous mobile robot. In some embodiments, the planned trajectory may be input to the planning and control system 120, which may be used to determine the method of implementation for the planned trajectory. For example, the planning and control system 120 may be configured to determine an operation speed, accelerations or decelerations, a drive line, and/or other trajectory variables that may be associated with the trajectory from the autonomy system 105.

In some embodiments, the planning and control system 120 may output multiple signals associated with the received trajectory. For example, the planning and control system 120 may be configured to output at least a steering signal, a braking signal, and a throttle signal. The multiple signals from the planning and control system 120 may be input into the drive by wire system 125, which may be used to control and/or operate the autonomous vehicle. One or more of the autonomy system 105, cooperative teleoperation module 110, planning and control system 120, and/or drive by wire system 125 may be implemented in the autonomous vehicle. In some embodiments, the teleoperator 115 may be configured to provide input to the cooperative teleoperation module 110. For example, the teleoperator 115 may provide an input that may be directly routed into the drive by wire system 125, such that the teleoperator 115 has remote, direct control over the autonomous vehicle. In some embodiments, the autonomous driving system 100 may be configured to receive teleoperator 115 input in control of the autonomous vehicle, such as in instances where navigation exceeds a complexity threshold. The teleoperator 115 may provide the steering, braking, throttle, and/or other trajectory components to the drive by wire system 125, which may be used to implement a trajectory for the autonomous vehicle while under the control of the teleoperator 115.

The autonomous driving system 100 may include cooperative teleoperation module (CTM) 110, in addition to the autonomy system 105, teleoperator 115, planning and control system 120, and drive by wire system 125. In some embodiments, the CTM 110 may be disposed between the autonomy system 105 and the planning and control system 120. In some embodiments, the trajectory output of the autonomy system 105 may be an input into the CTM 110. Alternatively or additionally, an output of the CTM 110 may include a trajectory that may be an input into the planning and control system 120. In some embodiments, the CTM 110 may introduce no changes to the trajectory, such that the trajectory output from the autonomy system 105 may be similar or identical to the trajectory input into the planning and control system 120. Alternatively or additionally, the trajectory may be varied or modified by the CTM 110.

In some embodiments, the CTM 110 may be configured to receive the trajectory from the autonomy system 105. Alternatively or additionally, the CTM 110 may be configured to receive input from the teleoperator 115. For example, input from the teleoperator 115 may include trajectory adjustments, motion authorization, and/or other controls or instructions from the teleoperator 115.

In some embodiments, the autonomy system 105 may provide a visual indication to the teleoperator 115 of the planned trajectory for the teleoperator 115 to review and/or authorize implementation. For example, the autonomy system 105 may provide a current visualization of the current navigation setting and may overlay the planned trajectory onto the visualization. In some embodiments, an output from the teleoperator 115 may include a trajectory adjustment to the planned trajectory output from the autonomy system 105. For example, an autonomy system 105 may determine a first trajectory and a teleoperator 115 may determine that a second trajectory is a better route for an autonomous vehicle. The teleoperator 115 may adjust the first trajectory to match the second trajectory to create the planned trajectory for the autonomous vehicle. Alternatively, and/or additionally, an output from the teleoperator 115 may include motion authorization. For example, the planned trajectory may be ready to be implemented and the teleoperator 115 may provide an indication to the system that the autonomous vehicle may proceed with the trajectory.

FIGS. 1B-1C include screen shots of an example teleoperator interface 130 depicting a planned trajectory for the teleoperator 115, in accordance with at least one embodiment of the present disclosure. In the example of FIG. 1B, the current visualization (e.g., from a forward-facing camera of the autonomous vehicle) includes a first trajectory 135 which is the current planned trajectory overlaid on the visualization. As illustrated in FIG. 1C, however, the teleoperator 115 may determine that a second trajectory 140 is a better route for the autonomous vehicle, e.g., due to an obstacle 145 in the first trajectory 135. The teleoperator 115 may provide the second trajectory 140 to the autonomous vehicle and/or may adjust the first trajectory 135 to match the second trajectory 140, e.g., by directing the autonomous vehicle to follow the second trajectory 140 instead of the first trajectory 135.

Returning to FIG. 1A, in these and other embodiments, the motion authorization provided by the teleoperator 115 may be partial or complete with respect to the planned trajectory from the autonomy system 105. For example, in a complex navigation setting, the autonomous driving system 100 may request motion authorization for all planned trajectories of an autonomous vehicle. In another example, an autonomous vehicle in a simpler navigable scenario may request motion control only when encountering more complex trajectories. Alternatively, and/or additionally, the cooperative teleoperation may not request any motion authorization and may operate independent of additional input from the teleoperator 115.

In these and other embodiments, the CTM 110 may be configured to receive inputs from both the autonomy system 105 and the teleoperator 115 and may use the inputs to determine the trajectory that may be transmitted to the planning and control system 120. For example, based on the initial trajectory from the autonomy system 105, the CTM 110 may adjust the trajectory based on input from the teleoperator 115, and may transmit the adjusted trajectory to the planning and control system 120.

In some embodiments, one or more of the autonomy system 105, the CTM 110, and/or the planning and control system 120 may remain in charge of the safety of the autonomous vehicle even when receiving or implementing input from the teleoperator 115. For example, while the planning and control system 120 is implementing a trajectory from the CTM 110 that is based on an initial trajectory from the autonomy system as authorized or modified by the teleoperator 115, the planning and control system 120 may determine whether and when it is safe to move and how to move and may output trajectory signals to the drive by wire system 125 that are consistent with its determinations.

The system 100 may implement one or more predefined operations or behaviors in the autonomous vehicle. The predefined operations or behaviors may include maintaining lane position, overtaking (e.g., other vehicles) on the left, collision avoidance, merging, or the like. In some embodiments, some portions or all of a given predefined operation or behavior may require authorization by the teleoperator 115. Alternatively or additionally, the system 100 may implement one or more on the fly operations or behaviors in the autonomous vehicle. On the fly operations or behaviors may include execution or implementation of trajectories input by the teleoperator 115.

Various degrees of functionality of cooperative teleoperation will now be described in three embodiments illustrating different modes of operation. In a first mode, the autonomy system 105 of the autonomous driving system 100 of an autonomous vehicle may generate a trajectory, may transmit the trajectory to the planning and control system 120 (e.g., through the CTM 110) which may implement control systems to achieve the trajectory, and may execute the planned trajectory using the drive by wire system 125. In some embodiments of the first mode, the autonomy system 105 may generate the trajectory, implement the trajectory, and execute the trajectory without any input from an outside source including the teleoperator 115. The autonomous vehicle may be capable of making the determinations based on learned scenarios, precise sensors, and/or an uncomplicated navigation environment. For example, an autonomous vehicle may be capable of navigating a roadway which has previously been traversed, and which may be substantially devoid of pedestrians and/or other less predictable objects.

In a second mode, the autonomy system 105 of the autonomous vehicle may interpret the surroundings and generate a suitable trajectory in response to the determined surroundings. Unlike the first mode, authorization to move may be under the direction of the teleoperator 115. In some embodiments, the teleoperator 115 may have control over the autonomous vehicle's movement using a control knob, a control lever, or other input device. In these and other embodiments, the teleoperator 115 may be able to throttle the degree of movement of an autonomous vehicle, in the autonomous vehicle's attempt to follow the determined trajectory. In some embodiments, the control exhibited by the teleoperator 115 over the autonomous vehicle may range from free autonomy to completely stopped. In these and other embodiments, the teleoperator 115 may determine the current navigation environment is too complex and may revert the entire system into direct teleoperation until the navigation setting may be less complex.

In a third mode, the autonomy system 105 may determine a trajectory, similar to the prior two modes. However, the teleoperator 115 may intervene in the trajectory using at least a control knob (similar to the control knob described with respect to the second mode) and a steering mechanism and/or other input device(s). In some embodiments, the autonomy system 105 may determine a trajectory that the teleoperator 115 desires to overrule or otherwise modify. In these and other embodiments, the teleoperator 115 may provide a modified trajectory using at least the steering mechanism (e.g., as in FIGS. 1B-1C). In some embodiments, the teleoperator 115 may provide movement authorization to the autonomous vehicle after the teleoperator 115 has modified the trajectory. Alternatively, and/or additionally, the teleoperator 115 may provide movement authorization to the autonomous vehicle prior to the teleoperator 115 modifying the trajectory. In these and other embodiments, the autonomy system 105 may continue to generate a trajectory for the autonomous vehicle after receiving the modified trajectory from the teleoperator 115.

In these and other embodiments, the trajectory from the autonomy system 105 may be combined with and/or altered by the trajectory or other input from the teleoperator 115 in the CTM 110. The CTM 110 may output the final trajectory to the planning and control system 120 which trajectory may include the trajectory from the autonomy system 105 and any alterations to the trajectory from the teleoperator 115.

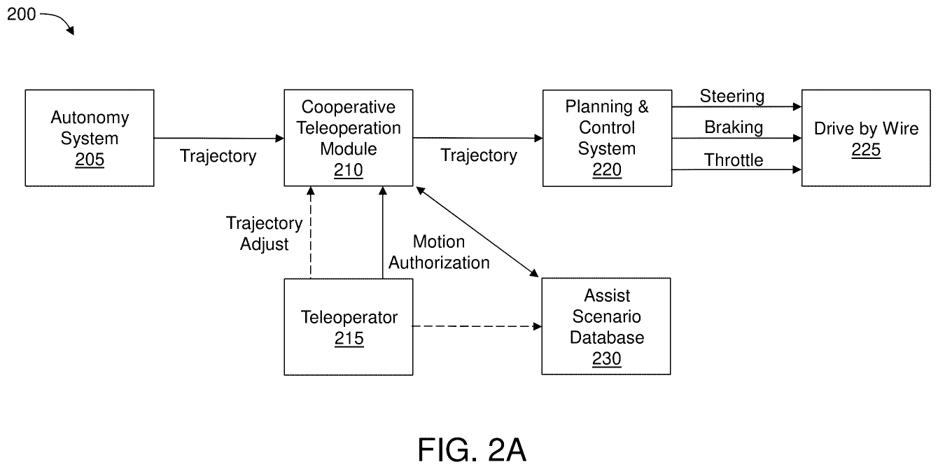

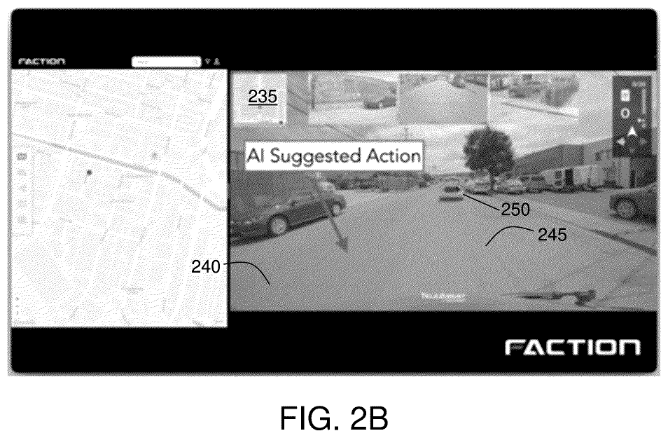

FIG. 2A illustrates an example autonomous mobile robot system 200, in accordance with at least one embodiment of the present disclosure. The autonomous mobile robot system 200 may include an autonomy system 205, CTM 210, teleoperator 215, planning and control system 220, drive by wire 225, and an assist scenario database 230. In some embodiments, the autonomy system 205, the CTM 210, the teleoperator 215, the planning and control system 220, and the drive by wire system 225 may collectively form an autonomous mobile robot system which may be the same as, similar to, and/or identical to the system 100 of FIG. 1A. Alternatively or additionally, the autonomy system 205, the CTM 210, the teleoperator 215, the planning and control system 220, and the drive by wire system 225 may be analogous, similar, or identical to, respectively, the autonomy system 105, the CTM 110, the teleoperator 115, the planning and control system 120, and the drive by wire system 125 of FIG. 1A. In the discussion that follows, the autonomous mobile robot system 200 is described as an autonomous vehicle system 200 or autonomous driving system 200 that includes an autonomous vehicle or driverless vehicle, but may more generally include an autonomous mobile robot system that includes an autonomous mobile robot.

In some embodiments, predefined operations or behaviors may be compiled into assist scenario database 230, which may be a library or catalog on or accessible to one or more of the autonomy system 205, the CTM 210, the planning and control system 220, or other component(s) of the cooperative teleoperation system 200. The predefined operations or behaviors may, in some embodiments, be automatically triggered or executed based on contextual information such as location, lane, hotspot type, time of day, season, weather conditions, agent (e.g., a specific teleoperator 215) involved, or other contextual information available to the cooperative teleoperation system 200. Alternatively or additionally, the predefined operations or behaviors in the library or catalog may initially require authorization from the teleoperator 215. Over time, the teleoperator 215 may repeatedly authorize one or more of the predefined operations or behaviors under conditions that are tracked, e.g., as contextual information. With enough contextual information accumulated over time for enough authorizations of a given predefined operation or behavior, the CTM 210 or other component(s) of the cooperative teleoperation system may learn when the predefined operation or behavior may be automatically executed without requiring express authorization from the teleoperator 215.

In some embodiments, the assist scenario database 230 implements an LLM artificial intelligence (AI) system, which results in a human-assisted, supervised autonomous driving system 200 that includes a cooperative teleoperation module 210, which serves as an action recommendation engine to the planning and control system 220, powered by the assist scenario database 230. In some embodiments, the assist scenario database 230 is also a GPT database, which may include a family of LLMs.

In an embodiment, the CTM 210 continuously learns by receiving and storing data from each and every drive performed by the driverless vehicle in the assist scenario database 230. Thus, the assist scenario database 230 collects drive data from the CTM 210, parses and stores that data, and sends relevant data from the stored data to the CTM 210 in future analogous scenarios, such as in complex drive scenarios, such as an unexpected road blockage, where the driverless vehicle does not readily know which operation to perform. Thus, the assist scenario database 230 causes the CTM 210 to be able to recognize, interpret, and respond to future various and potentially complex driving scenarios.

In some example embodiments, the remote human teleoperator 215 may provide an instruction to the CTM 210, and the assist scenario database 230 may store the teleoperator 215's instruction for future reference by the CTM 210, so that the CTM 210 may either recommend the stored instruction to the teleoperator 215 in future similar scenarios, or the CTM 210 may automatically instruct the driverless vehicle to perform the stored operation suggested by assist scenario database 230 without requiring teleoperator 215 approval, based on desired user settings, or based on other case scenarios and statistical probabilities as learned via the GPT/LLM assist scenario database 230.

In other embodiments, the assist scenario database 230 may resolve a complex driving scenario by choosing or suggesting a trajectory or course of action, and a human teleoperator 215 may review, adjust, validate, authorize, and/or approve the trajectory or course of action chosen, and the assist scenario database 230 may remember the chosen trajectory or course, and remember that it was approved, or otherwise responded to, by the human teleoperator 215. In this manner, the autonomy system 205 and the CTM 210 therein utilizes LLM to learn and scale, and predict its own response and course of action to complex, unexpected driving scenarios. The actions, instructions, choices, and/or validations of the human teleoperator 215 are fed back into the assist scenario database 230, such that its knowledge and performance are improved over time. Thereby, a training loop develops an assist scenario database 230 into a fully autonomous driving vehicle system 200, where the assist scenario database 230 is continuously learning and improving from the input of human teleoperators 215 as well as each drive performed by the driverless vehicle, and the workload of the teleoperators 215 is reduced as the assist scenario database 230 improves.

Alternatively or additionally, the assist scenario database 230 may be trained using simulated operational scenarios. For example, an AI may simulate operational scenarios that involve control, trajectory, and/or behavior of the autonomous vehicle in addition to real-world input from the teleoperator 215. The simulated scenarios may be fed into the assist scenario database 230 to further improve its knowledge and performance.

In some embodiments, when a driverless vehicle encounters a complex driving situation, the CTM 210 consults the assist scenario database 230 and suggests a trajectory and vehicle actions for the remote teleoperator 215 to choose from. The CTM 210 then awaits confirmation of the suggested trajectory, or a modification of the suggested trajectory, by the human teleoperator 215 as input to refine scenarios. This process enhances the decision-making capability of the teleoperator 215 by providing them with data-backed suggestions in real-time, but offers the safety of not allowing an AI agent to make a final decision.

FIG. 2B includes a screen shot of an example teleoperator interface 235 depicting a trajectory 240 chosen or suggested by the CTM 210 or the assist scenario database 230 for the teleoperator 215, in accordance with at least one embodiment of the present disclosure. In the example of FIG. 2B, the current visualization (e.g., from a forward-facing camera of the autonomous vehicle) includes a first or initial trajectory 245. In response to detecting an obstacle 250 in the first trajectory 245 or other complex driving scenario, the assist scenario database 230 may suggest instead the trajectory 240. The teleoperator 215 may review, adjust, validate, authorize, and/or approve the chosen or suggested trajectory 240 or course of action, and the CTM 210 and/or the assist scenario database 230 may remember the chosen trajectory or course, and remember that it was approved, or otherwise responded to, by the human teleoperator 215. In some embodiments, the scenario depicted in FIG. 2B in which the assist scenario database 230 suggests the trajectory 240 as an alternative to the first trajectory 245 to the teleoperator 215 and the teleoperator 215 merely has to approve the trajectory 240 may take significantly less teleoperator interaction time than the scenario depicted in FIGS. 1B-1C in which the teleoperator 215 has to determine and input the second trajectory 140 in place of the first trajectory 135. For example, the scenario depicted in FIGS. 1B-1C may involve approximately 30 seconds of teleoperator 115 interaction compared to approximately a few seconds of teleoperator 215 interaction for the scenario depicted in FIG. 2B.

Returning to FIG. 2A, the assist scenario database 230 may also reduce the cognitive workload on teleoperators 215 by causing the CTM 210 or assist scenario database 230 to suggest actions and scenarios, which may allow teleoperators 215 to focus on higher-level tasks, maintain performance over extended shifts, oversee a larger amount of driverless vehicles, and therefore increase efficiency and reduce overall costs. In other embodiments, after the CTM 210 has received authorization to perform certain actions suggested by the assist scenario database 230 in particular scenarios at a statistically significant threshold, the authorized actions may then propagate to the vehicle from the assist scenario database 230 and execute by CTM 210 unsupervised, i.e., without need for teleoperator 215's authorization or approval.

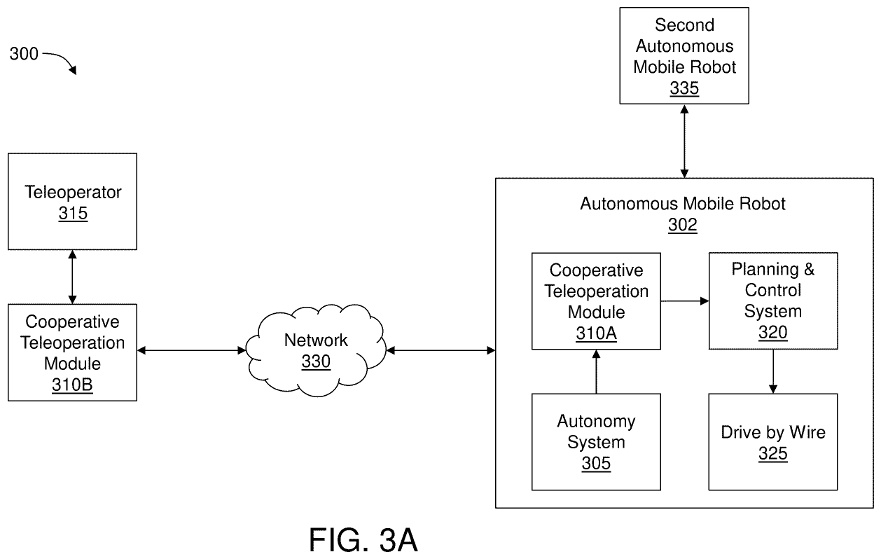

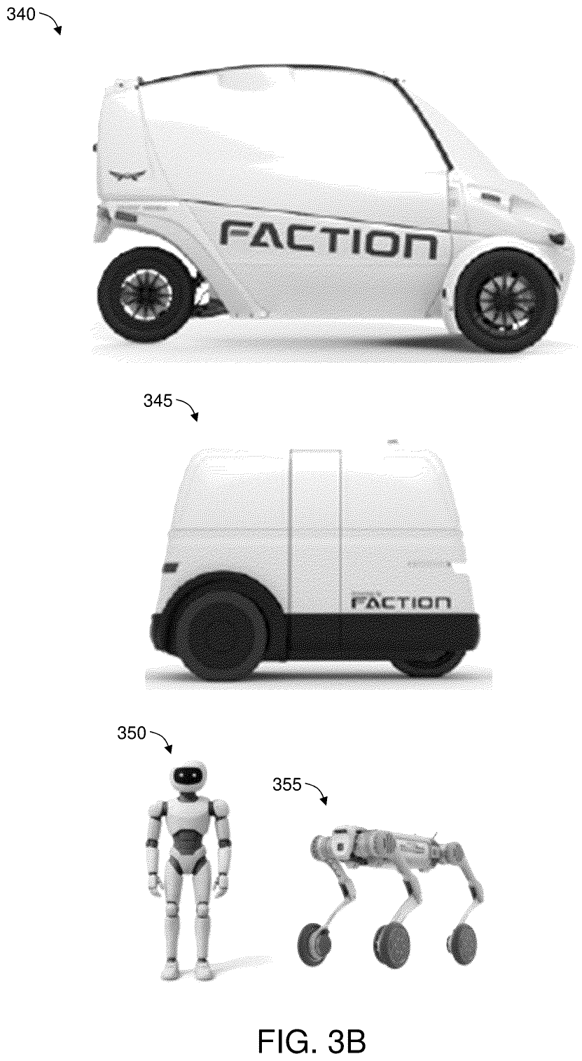

FIG. 3A illustrates an example operating environment 300 for an autonomous mobile robot system, in accordance with at least one embodiment of the present disclosure. The environment 300 may include an autonomous mobile robot 302, a teleoperator 315, and a network 330. In the discussion that follows, the autonomous mobile robot system and the autonomous mobile robot 302 are described as an autonomous vehicle system or autonomous driving system that includes an autonomous vehicle 302 or driverless vehicle 302, but may more generally include an autonomous mobile robot system that includes an autonomous mobile robot 302.

The autonomous vehicle 302 may include an autonomy system 305, a CTM, a planning and control system 320, and a drive by wire system 325. The CTM may include a first component 310A (hereinafter “CTM 310A”) and a second component 310B (hereinafter “CTM 310B”) described in more detail elsewhere herein, and which may collectively be referred to herein as CTM 310.

The CTM 310A may be implemented on the autonomous vehicle 302 while the CTM 310B may be implemented in the cloud, e.g., on a server, or otherwise remotely from the autonomous vehicle 302. The CTMs 310A, 310B may “talk” to each other, e.g., exchange communications. The functionality of the CTM 310 described herein may be distributed evenly or unevenly between the CTMs 310A, 310B.

In some embodiments, the autonomy system 305, the CTM 310, the teleoperator 315, the planning and control system 320, and the drive by wire system 325 may collectively form an autonomous driving vehicle system which may be the same as, similar to, and/or identical to the system 100 of FIG. 1A. Alternatively or additionally, the autonomy system 305, the CTM 310, the teleoperator 315, the planning and control system 320, and the drive by wire system 325 may be analogous, similar, or identical to, respectively, the autonomy system 105, the CTM 110, the teleoperator 115, the planning and control system 120, and the drive by wire system 125 of FIG. 1A.

In some embodiments, the network 330 may be configured to communicatively couple the teleoperator 315 and the autonomous vehicle 302, e.g., via the CTM 310. In some embodiments, the network 330 may be any network or configuration of networks configured to send and receive communications between systems. In some embodiments, the network 330 may include the Internet, including a global internetwork formed by logical and physical connections between multiple WANs and/or LANs. Alternately or additionally, the network 330 may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network 330 may also include servers that enable one type of network to interface with another type of network.

In some embodiments, the autonomous driving vehicle system of FIG. 1A (i.e., the cooperative teleoperation system collectively formed by the autonomy system 105, the CTM 110, the teleoperator 115, the planning and control system 120, and the drive by wire system 125) may be configured to operate similar or identical to autonomous driving vehicle system of FIG. 3A. For example, the autonomous vehicle 302 may be controlled by a combination of the autonomy system 305, the CTM 310, the teleoperator 315, the planning and control system 320, and/or the drive by wire system 325. In some embodiments, the autonomous driving vehicle system of FIG. 3A may provide operation of the autonomous vehicle 302 where one or more of the components of the system may be remote from the autonomous vehicle 302. For example, as illustrated, the teleoperator 315 and the CTM 310B may be remote from the autonomous vehicle 302 which may include the autonomy system 305, the CTM 310A, the planning and control system 320, and the drive by wire system 325. Alternatively or additionally, one or more of the components associated with the autonomous vehicle 302 in FIG. 3A may be located in a system associated with the teleoperator 315, the network 330, and/or any other remote system.

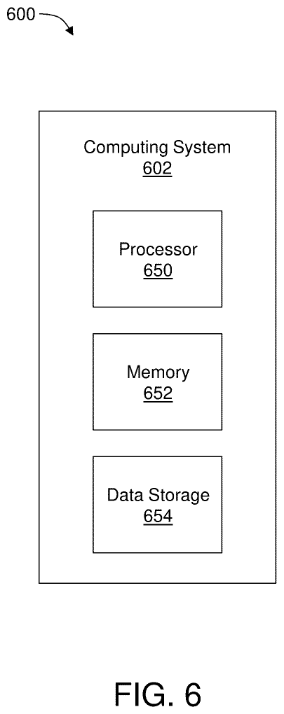

In some embodiments, some or all the operations performed by the teleoperator 315, the CTM 310B, and/or the components of the autonomous vehicle 302 (e.g., the autonomy system 305, the CTM 310A, the planning and control system 320, and the drive by wire system 325) may be performed by a computing system, such as the computing system 602 of FIG. 6.

Although not illustrated in FIG. 3A, the autonomous vehicle 302 may include one or more sensors and/or other hardware and/or software to detect and/or remotely monitor an environment and/or context of the autonomous vehicle 302. For example, the autonomous vehicle 302 may include one or more video cameras, a communication device, an accelerometer, a gyroscope, a global positioning system (GPS) device, a radar device, a LIDAR device, a thermal infrared device, an ultrasonic device, and/or other sensors. The one or more sensors, hardware, and/or software may, in some embodiments, be arranged and/or operated as described in U.S. patent application Ser. No. 18/316,119, filed May 11, 2023, and entitled DYNAMIC 360-DEGREE VIRTUAL SENSOR MAPPING, and which is incorporated herein by reference in its entirety. Some or all of the data (e.g., video feeds) generated at the autonomous vehicle 302 may be provided to the teleoperator 315, e.g., as described in the '119 application for monitoring and/or teleoperation. Providing such data to the teleoperator 315 may provide the teleoperator 315 with sufficient context, or situational awareness, to intervene in the operation of and/or assist the autonomous vehicle 302, e.g., to alter a planned trajectory, authorize a planned behavior, or the like.

Monitoring the autonomous vehicle 302 (e.g., as facilitated by the one or more sensors, hardware, and/or software) may include or involve an ability to see telemetry such as speed, turn indicators, parking brakes, gear states, and location information; an ability to get contextual information of the autonomous vehicle 302 such as camera streams from some or all angles and/or thermal camera images or streams; an ability to visualize a planned trajectory and/or a planned behavior of the autonomous vehicle 302; and/or an ability to flag events and create recordings that may be analyzed later for continuous improvement of the technology stack.

In these and other embodiments, the input provided by the teleoperator 315 to the autonomous vehicle 302 (and specifically, to the CTM 310) may include course correction of vehicle pathing, behavior authorization, readying the autonomous vehicle 302 for deployment on a mission, selecting a maximum authorized speed for the autonomous vehicle 302, resuming full autonomous operation on a mission after receiving input from the teleoperator 315, control of a parking brake and/or hazard lights of the autonomous vehicle, and/or other input. In some embodiments, the input provided by the teleoperator 315 to the autonomous vehicle 302 excludes vehicle finer control such as steering, braking, throttle control, or the like due to safety concerns around latency and bandwidth.

Although not necessarily illustrated in FIG. 3A, in some embodiments the CTM 310 may include one or more of the following in different locations of the system: a control surface, a user interface (UI), backend cloud infrastructure, and/or an on-vehicle system. The control surface may include a generic or dedicated hardware controller that links up with the UI and allows the teleoperator 315 to take any relevant actions. The UI may include a web application that runs on any web browser (or other application) with authentication that the teleoperator 315 may use to get context of the vehicle in terms of, e.g., a telemetry feed, real-time camera streams, and vehicle intent. The UI may also be used to give feedback to the teleoperator 315 for status of commands that are issued. The backend infrastructure may include a system that resides in, e.g., the AWS cloud (or more generally, in the network 330) that is responsible for the commands and the telemetry feed & camera streams exchanged between the teleoperator 315 and the autonomous vehicle 302 in a safe and secure way that is scalable for many users and fleets of autonomous vehicles. The on-vehicle system may include a system that relays all the telemetry and camera feed and/or other data from the autonomous vehicle 302 to the backend cloud infrastructure and receives commands from the teleoperator 315 to carry out the commands in conjunction with the planning and control system 320. Other arrangements of the foregoing components and/or of the CTM 310 itself are also contemplated and within the scope of the present disclosure.

In some embodiments, the operating environment 300 further includes a second autonomous mobile robot 335 that may be used to handle a “last 100 foot” type of challenge with some locations in the context of, e.g., package pickup or delivery. In this and other embodiments, the autonomous vehicle 302 may have a size or configuration that is suitable for a first environment, e.g., traversing roads, highways, and freeways with other vehicular traffic. However, this size or configuration may not be suitable for a second environment, e.g., the initial and/or final segments of a route (e.g., a route for a pickup and/or delivery) as the initial and/or final segments may traverse sidewalks, walkways, buildings, or the like in which the autonomous vehicle 302 may not fit and/or may not be permitted.

The second mobile robot 335 may have a smaller and/or different size or configuration than the autonomous vehicle 302 which may be suitable for and/or permitted on or in the second environment, e.g., sidewalks, walkways, buildings, or the like. As such, the second mobile robot 335 may be deployed for the initial and/or final segments of a route. In this and other embodiments, the second mobile robot 335 may dock to or in or be carried on or in the autonomous vehicle 302. The second mobile robot 335 may be smaller than the autonomous vehicle 302 with the same or different general form factor (albeit smaller). For example, the autonomous vehicle 302 may include a 3-wheeled vehicle and the second mobile robot 335 may include a size downscaled version of the autonomous vehicle 302. As another example, the autonomous vehicle 302 may include a wheeled vehicle while the second mobile robot 335 may include an aerial vehicle, a humanoid robot, or other mobile robot.

In some embodiments, the second mobile robot 335 may take advantage of the autonomous vehicle 302 as a relay for commands. For example, the autonomous vehicle 302 already contains compute and communications, so the second mobile robot 335 itself may be “dumber” since it may leverage any AI models that are run on the hardware of the autonomous vehicle 302 for planning, control, mapping, or the like. Any software running on the vehicle, e.g., the autonomy system 305, the CTM 310A, the planning and control system 320, or the like, may be leveraged by the second mobile robot 335 or a robot-specific software application may launch on the autonomous vehicle 302 and run remote to control the second mobile robot 335.

In some embodiments the second mobile robot 335 may not have a cellular link, i.e., the second mobile robot 335 may be unable to communicate directly over a cellular network, since the autonomous vehicle 302 has a cellular link. In this and other embodiments, the autonomous vehicle 302 with the cellular link may relay communications between the teleoperator 315 and the second mobile robot 335, e.g., for any help requests the second mobile robot 335 might need using all the same mechanisms that the autonomous vehicle 302 uses. The second mobile robot 335 may have a short-range wireless link (e.g., Wi-Fi, Bluetooth) to the autonomous vehicle 302.

Alternatively or additionally, the second mobile robot 335 may include the same or similar components as the autonomous vehicle 302, including a cooperative teleoperation module 310A, a planning and control system 320, an autonomy system 305, and/or a drive (or control) by wire system 325, that may operate in the same or similar manner as in the autonomous vehicle 302. In an example use case, the autonomous vehicle 302 may generally operate autonomously and/or semi-autonomously with occasional teleoperator assistance for most of a route while the second mobile robot 335 may deploy from the autonomous vehicle 302 to handle an initial and/or final segment of the route (on which the autonomous vehicle 302 is not permitted and/or cannot traverse) and may generally operate autonomously and/or semi-autonomously with occasional teleoperator assistance for the initial and/or final segment of the route.

FIG. 3B illustrates various example mobile robots 340, 345, 350, 355 that may be implemented in, e.g., the operating environment 300 of FIG. 3A, in accordance with at least one embodiment of the present disclosure. The mobile robots 340, 345 include wheeled vehicles that may include, be included in, or correspond to the autonomous vehicle 302 of FIG. 3A. The mobile robots 350, 355 include a humanoid robot 350 and a small, wheeled vehicle 355 that may include, be included in, or correspond to the second mobile robot 335 of FIG. 3A. In some embodiments, the mobile robot 350 or 355 may generally be carried within the mobile robot 340, 345 and may be deployed from the mobile robot 340, 345 for the initial and/or final segment of a route.

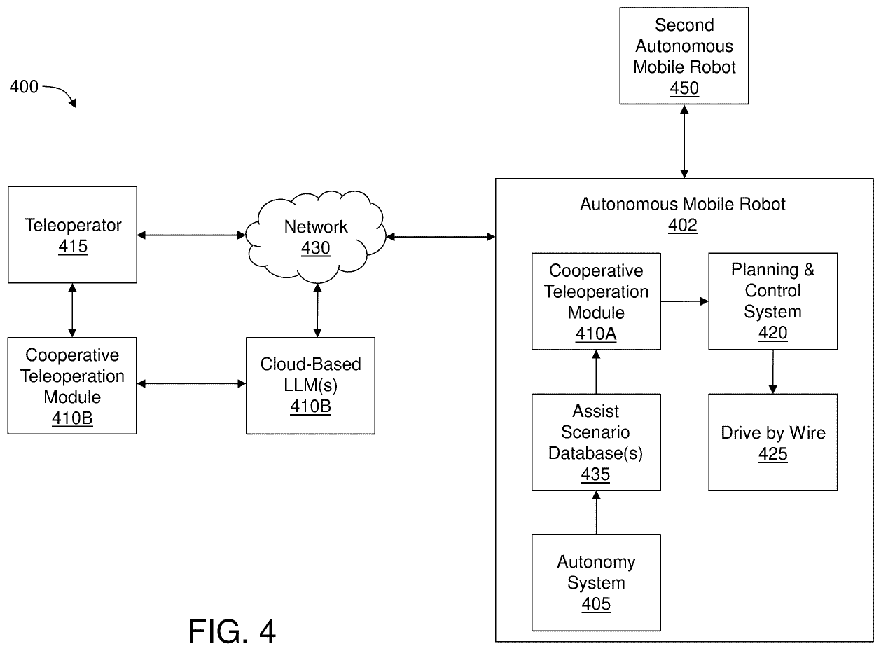

FIG. 4 illustrates an example operating environment 400 for an autonomous mobile robot system, in accordance with at least one embodiment of the present disclosure. The environment 400 may include an autonomous mobile robot 402 with an autonomy system 405, a CTM 410A, a planning and control system 420, and a drive by wire 425. The system may also locally or remotely include an assist scenario database 435, as well as a teleoperator 415, a network 430, a CTM 410B, and one or more cloud-based LLMs 445. In the discussion that follows, the autonomous mobile robot system and the autonomous mobile robot 402 are described as an autonomous vehicle system or autonomous driving system that includes an autonomous vehicle 402 or driverless vehicle 402, but may more generally include an autonomous mobile robot system that includes an autonomous mobile robot 402.

In some embodiments, the autonomy system 405, the CTM 410, the assist scenario database 435, the teleoperator 415, the planning and control system 420, and the drive by wire system 425 may collectively form an autonomous vehicle system which may be the same as, similar to, and/or identical to the system 200 of FIG. 2A. Alternatively or additionally, the autonomy system 405, the CTM 410, the assist scenario database 435, the teleoperator 415, the planning and control system 420, and the drive by wire system 425 may be analogous, similar, or identical to, respectively, the autonomy system 205, the CTM 210, the assist scenario database 230, the teleoperator 215, the planning and control system 220, and the drive by wire system 225 of FIG. 2A. In some embodiments, the autonomy system 405, the CTM 410A and CTM 410B, the teleoperator 415, the planning and control system 420, and the drive by wire system 425 may collectively form an autonomous driving vehicle system which may be the same as, similar to, and/or identical to the system as shown in FIG. 3A.

In some embodiments, the CTM 402 may utilize the assist scenario database 435, or may utilize multiple assist scenario databases 435, and combinations of assist scenario databases 435, i.e., combinations of LLMs or discrete LLMs, such as a driving intersection LLM, a traffic light LLM, an overtake LLM, a free space LLM, and combinations thereof. Furthermore, in some embodiments, not only is the assist scenario database 435 created and/or improved by collecting real-time driving data, the assist scenario database 435 may also be initially generated by receiving one or more Cloud-Based LLMs 445 via network 430. In some embodiments, the assist scenario database 435 may be updated with additional or modified Cloud-Based LLMs 445. In another embodiment, the assist scenario database 435 runs entirely in the cloud, i.e., the assist scenario database 435 does not store any of its own information on the vehicle, but rather, stores and receives all data to and from Cloud-Based LLM(s) 445, which may serve to save power on the vehicle, and which may make updating the assist scenario database 435 centralized, efficient, reliable and routine. In other embodiments, authorized actions performed by the driverless vehicle(s) in particular scenarios may propagate from the cloud-based LLM(s) 445 to the assist scenario database 435 of the vehicle(s) and be executed unsupervised. Cloud-based architecture may result in low-cost vehicle hardware, thereby reducing overall vehicle costs.

In some embodiments, the operating environment 400 further includes a second autonomous mobile robot 450, e.g., that may be used to handle the “last 100 foot” type of challenge. In this and other embodiments, the second mobile robot 450 may dock to or in or be carried on or in the autonomous vehicle 402. The second mobile robot 450 may be smaller than the autonomous vehicle 402 with the same or different general form factor (albeit smaller). For example, the autonomous vehicle 402 may include a 3-wheeled vehicle and the second mobile robot 450 may include a size downscaled version of the autonomous vehicle 402. As another example, the autonomous vehicle 402 may include a wheeled vehicle while the second mobile robot 450 may include an aerial vehicle, a humanoid robot, or other mobile robot.

In some embodiments, the second mobile robot 450 may take advantage of the autonomous vehicle 402 as a relay for commands. For example, the autonomous vehicle 402 already contains compute and communications, so the second mobile robot 450 itself may be “dumber” since it may leverage any AI models that are run on the hardware of the autonomous vehicle 402 for planning, control, mapping, or the like. Any software running on the vehicle, e.g., the autonomy system 405, the CTM 410A, the planning and control system 420, or the like, may be leveraged by the second mobile robot 450 or a robot-specific software application may launch on the autonomous vehicle 402 and run remote to control the second mobile robot 450.

In some embodiments the second mobile robot 450 may not have a cellular link, i.e., the second mobile robot 450 may be unable to communicate directly over a cellular network, since the autonomous vehicle 402 has a cellular link. In this and other embodiments, the autonomous vehicle 402 with the cellular link may relay communications between the teleoperator 415 and the second mobile robot 450, e.g., for any help requests the second mobile robot 450 might need using all the same mechanisms that the autonomous vehicle 402 uses. The second mobile robot 450 may have a short-range wireless link (e.g., Wi-Fi, Bluetooth) to the autonomous vehicle 402.

Alternatively or additionally, the second mobile robot 450 may include the same or similar components as the autonomous vehicle 402, including a cooperative teleoperation module 410A, a planning and control system 420, an autonomy system 405, and/or a drive (or control) by wire system 425, that may operate in the same or similar manner as in the autonomous vehicle 402. In an example use case, the autonomous vehicle 402 may generally operate autonomously and/or semi-autonomously with occasional teleoperator assistance for most of a route while the second mobile robot 450 may deploy from the autonomous vehicle 402 to handle an initial and/or final segment of the route (on which the autonomous vehicle 402 is not permitted and/or cannot traverse) and may generally operate autonomously and/or semi-autonomously with occasional teleoperator assistance for the initial and/or final segment of the route.

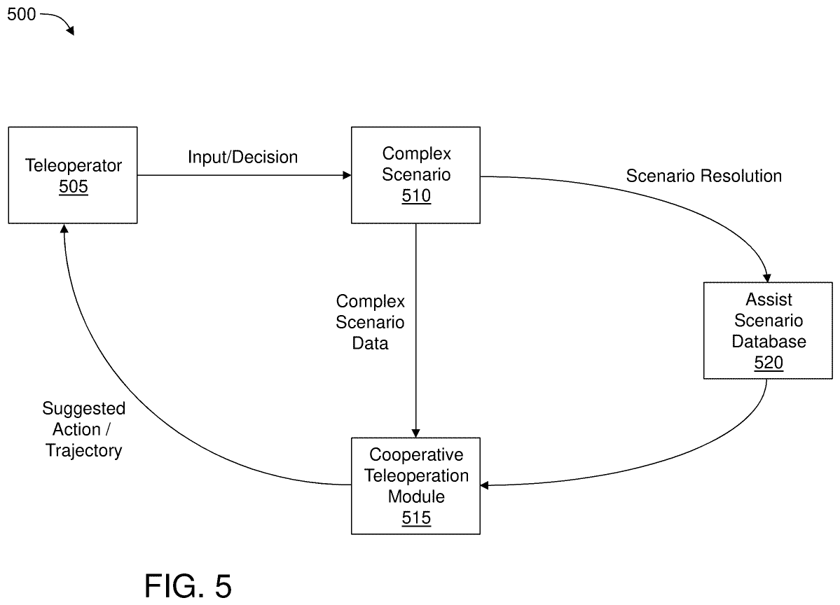

FIG. 5 a flowchart of an example method of an autonomous mobile robot system 500 with an assist scenario database 520, in accordance with at least one embodiment of the present disclosure. The method of FIG. 5 is discussed as a method of an autonomous driving vehicle system but extends more generally to an autonomous mobile robot system.

The example method of FIG. 5 includes as a first step an autonomous driving vehicle (or an autonomous mobile robot more generally) embarking on a drive path. As a second step, the driverless vehicle may encounter a complex scenario 510, such as a road blockage, traffic light, limit line, or other fixed item in the driving environment that has made driving complex or dangerous. The complex scenario 510 may be considered an “object” for purposes of the assist scenario database LLM. A CTM 515 receives the indication of a complex scenario 510 and the complex scenario data, and requests a scenario resolution from the assist scenario database 520. The assist scenario database 520 determines a scenario resolution, sends the suggested action or trajectory, i.e., suggested resolution, to the CTM 515, which sends the suggested action or trajectory for approval by a teleoperator 505. The teleoperator 505 authorizes, modifies, or rejects the suggested resolution, or may perform some other action, including but not limited to course line adjustments, speed control, and authorizations to move. The resolution in response to the complex drive scenario may be considered an “action” for purposes of the assist scenario database LLM. The teleoperator 505's action is transmitted to the assist scenario database 520, via the CTM 515, and the action is stored on the assist scenario database 520, for future reference in similar scenarios, so that it may be suggested or executed. Thus, the combination of an object and an action being fed into the assist scenario database 520 allows it to learn the object-action relationship to present the suggested scenario in a future complex drive scenario.

FIG. 6 illustrates a block diagram of an example computing system 602, in accordance with at least one embodiment of the present disclosure. The computing system 602 may be configured to implement or direct one or more operations associated with an autonomous mobile robot system, such as an autonomous driving vehicle system, in accordance with the present disclosure (e.g., the autonomous driving vehicle system 200 of FIG. 2A). In some embodiments, the computing system 602 may be implemented or included in an autonomous mobile robot, such as an autonomous vehicle including the autonomous vehicle 402 of FIG. 4. The computing system 602 may include a processor 650, a memory 652, and a data storage 654. The processor 650, the memory 652, and the data storage 654 may be communicatively coupled.

In general, the processor 650 may include any suitable special-purpose or general-purpose computer, computing entity, or processing device including various computer hardware or software modules and may be configured to execute instructions stored on any applicable computer-readable storage media. For example, the processor 650 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, the processor 650 may include any number of processors configured to, individually or collectively, perform or direct performance of any number of operations described in the present disclosure. Additionally, one or more of the processors may be present on one or more different electronic devices, such as different servers.

In some embodiments, the processor 650 may be configured to interpret and/or execute program instructions and/or process data stored in the memory 652, the data storage 654, or the memory 652 and the data storage 654. In some embodiments, the processor 650 may fetch program instructions from the data storage 654 and load the program instructions in the memory 652. After the program instructions are loaded into memory 652, the processor 650 may execute the program instructions.

For example, in some embodiments, program instructions may be included in the data storage 654. The processor 650 may fetch the program instructions of a corresponding module from the data storage 654 and may load the program instructions of the corresponding module in the memory 652. After the program instructions of the corresponding module are loaded into memory 652, the processor 650 may execute the program instructions such that the computing system may implement the operations associated with the corresponding module as directed by the instructions.

The memory 652 and the data storage 654 may include computer-readable storage media for carrying or having computer-executable instructions or data structures stored thereon. Such computer-readable storage media may include any available media that may be accessed by a general-purpose or special-purpose computer, such as the processor 650. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 650 to perform a certain operation or group of operations.

Modifications, additions, or omissions may be made to the computing system 402 without departing from the scope of the present disclosure. For example, in some embodiments, the computing system 602 may include any number of other components that may not be explicitly illustrated or described.

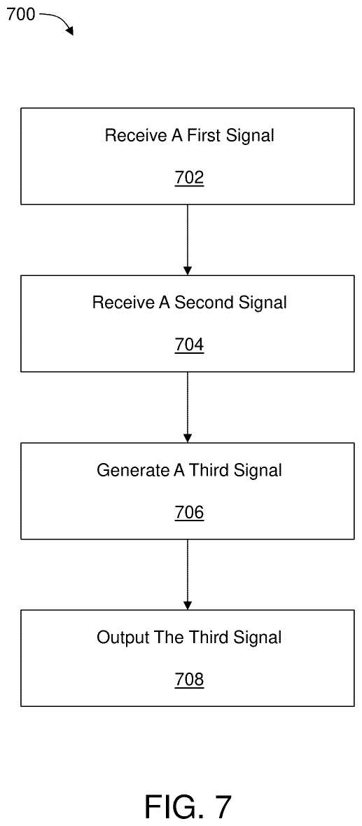

FIG. 7 is a flowchart of an example method 700 to control an autonomous mobile robot, in accordance with at least one embodiment of the present disclosure. The method 700 may be performed by any of the systems, modules, and/or devices described herein, such as the autonomous mobile robot system of FIGS. 2A, 3A, or 4A, the CTM 210, 310, 410 or the like. In some embodiments, the method 700 may be embodied in code or other computer-readable instructions stored in a memory or other computer-readable storage media and executable by a processor, such as the processor 650 of FIG. 6, to cause the processor to perform or control performance of one or more of the functions or operations of the method 700. The method 700 may be performed by processing logic that may include hardware (circuitry, dedicated logic, etc.), software (such as is run on a computer system or a dedicated machine), or a combination of both, which processing logic may be included in, e.g., the processor 650 of FIG. 6 or another device, combination of devices, or systems. The method 700 may include one or more of blocks 702, 704, 706, and/or 708.

At block 702, the method 700 may include receiving a first signal. The first signal may include a first set of parameters that define a planned trajectory for the autonomous mobile robot. In some embodiments, receiving the first signal may include the CTM 210 receiving the trajectory from the autonomy system 205. Alternatively or additionally, the first set of parameters may be obtained from a library of predefined parameters. The library of predefined parameters may include predefined deterministic behaviors for the autonomous mobile robot in response to a stimulus. The predefined deterministic behaviors may include at least one of throttle control, brake control, steering control to maintain lane-keeping, distance control to maintain distance between the autonomous mobile robot and other vehicles, overtaking other vehicles on the left, collision avoidance, or merging. Block 702 may be followed by block 704.

At block 704, the method 700 may include receiving a second signal. The second signal may include a second set of parameters that define a planned trajectory for the autonomous mobile robot. In some embodiments, receiving the second signal may include the CTM 210 receiving the trajectory adjustment or motion (or other behavior) authorization from the teleoperator 215. Alternatively or additionally, the second set of parameters may include input from a teleoperator. For example, the input from the teleoperator may include at least one of an alteration or modification to the planned trajectory defined by the first parameters or an authorization of some or all of the planned trajectory. Block 704 may be followed by block 706.

At block 706, the method 700 may include generating a third signal. The third signal may be generated by modifying the first set of parameters of the first signal to include the second set of parameters of the second signal. In some embodiments, generating the third signal may include the CTM 210 generating the third signal based on the trajectory signal from the autonomy system and one or both of the trajectory adjustment or motion (or other behavior) authorization from the teleoperator 215. Block 706 may be followed by block 708.

At block 708, the method 700 may include outputting the third signal. In some embodiments, outputting the third signal at block 708 includes the CTM 210 outputting the updated trajectory and/or authorized behavior to the planning and control system 220.

Modifications, additions, or omissions may be made to the method 700 without departing from the scope of the present disclosure. For example, in some embodiments, the method 700 may include any number of other blocks that may not be explicitly illustrated or described. Alternatively, or additionally, one or more blocks included in the method 700 may be performed sequentially, or in parallel, as applicable.

As a particular example, the method 700 may further include determining trajectory components to implement a trajectory defined by the third signal and executing the trajectory defined by the third signal. Executing the trajectory defined by the third signal may include executing the trajectory components at a drive by wire system of the autonomous mobile robot, such as the drive by wire system 225 of FIG. 2A. As another example, the method 700 may further include, prior to executing the trajectory defined by the third signal, determining whether it is safe to implement the trajectory defined by the third signal, or determining which trajectory to implement, e.g., by utilizing assist scenario database 230 in FIG. 2A. In this and other embodiments, executing the trajectory defined by the third signal may occur only after determining that it is safe to execute the trajectory defined by the third signal.

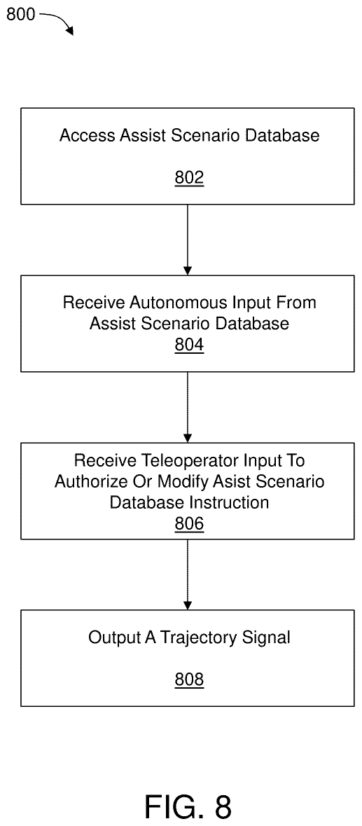

FIG. 8 is a flowchart of another example method 800 to control an autonomous mobile robot system utilizing an assist scenario database, in accordance with at least one embodiment of the present disclosure. The method 800 may be performed by any of the systems, modules, and/or devices described herein, such as the autonomous mobile robot system of FIGS. 2A, 3A, or 4A, the CTM 210, 310, or the like. In some embodiments, the method 800 may be embodied in code or other computer-readable instructions stored in a memory or other computer-readable storage media and executable by a processor, such as the processor 650 of FIG. 6, to cause the processor to perform or control performance of one or more of the functions or operations of the method 800. The method 800 may be performed by processing logic that may include hardware (circuitry, dedicated logic, etc.), software (such as is run on a computer system or a dedicated machine), or a combination of both, which processing logic may be included in, e.g., the processor 650 of FIG. 6 or another device, combination of devices, or systems. The method 800 may include one or more of blocks 802, 804, 806, and/or 808.

At block 802, the method 800 may include accessing an assist scenario database to determine a course of action when a mobile robot, such as driverless vehicle, has encountered a complex scenario. Block 802 may be followed by block 804.

At block 804, the method may include receiving an autonomous input from the assist scenario database. The autonomous input may include one or both of a suggested trajectory or a suggested behavior or instruction. In some embodiments, receiving the autonomous input may include the CTM 210 receiving the trajectory or a suggested behavior or instruction from the assist scenario database 230. Alternatively or additionally, the autonomous input includes the suggested behavior or instruction and the suggested instruction is automatically triggered based on contextual information assessed by the CTM 210 in view of knowledge stored in and processed by the assist scenario database 230. The contextual information may include at least one of a geographic location, a lane location, a hotspot type, a time of day, a season, weather conditions, or a current teleoperator for the autonomous vehicle. In some embodiments, the autonomous input includes the suggested behavior, the suggested behavior is obtained from a library of predefined behaviors, and the predefined behaviors are populated in the library over time based on prior authorizations of the predefined behaviors by a plurality of teleoperators, LLMs/GPTs, and/or cloud-based LLMs. Alternatively or additionally, the planned behavior may include at least one of throttle control, brake control, steering control to maintain lane-keeping, distance control to maintain distance between the autonomous vehicle and other vehicles, overtaking other vehicles on the left, collision avoidance, or merging. Block 804 may be followed by block 806.

At block 806, the method 800 may include receiving teleoperator input, e.g., from a teleoperator. The teleoperator input may include one or both of a suggested trajectory adjustment or a behavior authorization. In some embodiments, receiving the teleoperator input may include the CTM 210 receiving the trajectory adjustment or motion (or other behavior) authorization from the teleoperator 215. Block 806 may be followed by block 808.

At block 808, the method 800 may include outputting a trajectory signal that depends on both the autonomous input and the teleoperator input. The trajectory signal may include one or both of an updated suggested trajectory or an authorized suggested behavior. In some embodiments, outputting the trajectory signal at block 808 includes the CTM 210 outputting the updated trajectory and/or authorized behavior to the planning and control system 220. Alternatively or additionally, the method 800 further includes executing the updated planned trajectory or the authorized planned behavior, including executing the trajectory components at a drive by wire system of the autonomous vehicle.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B. ” This interpretation of the phrase “A or B” is still applicable even though the term “A and/or B” may be used at times to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method to control an autonomous mobile robot, the method comprising:
receiving autonomous input for an autonomous mobile robot from an assist scenario database, the autonomous input comprising one or both of a suggested trajectory or a suggested behavior;
receiving teleoperator input comprising one or both of a suggested trajectory adjustment or a suggested behavior authorization;
outputting a trajectory signal that depends on both the autonomous input and the teleoperator input, the trajectory signal comprising one or both of an updated trajectory or an authorized behavior; and
storing one or more of the autonomous input, the teleoperator input, the suggested trajectory adjustment, the suggested behavior authorization, or the trajectory signal in the assist scenario database.

2. The method of claim 1, further comprising recalling from the assist scenario database one or both of the teleoperator input or the trajectory signal in a complex driving scenario.

3. The method of claim 1, wherein the assist scenario database is comprised of one or more large language models.

4. The method of claim 3, wherein the autonomous input comprises the suggested behavior and the suggested behavior is automatically triggered based on the one or more large language models and contextual information.

5. The method of claim 4, wherein the contextual information includes at least one of a geographic location, a lane location, a complex scenario type, a time of day, a season, weather conditions, or a current teleoperator for the autonomous vehicle.

6. The method of claim 1, wherein the assist scenario database receives data from one or more cloud-based large language models and wherein the assist scenario database sends data to one or more cloud-based large language models.

7. The method of claim 1, wherein the autonomous input comprises the suggested behavior, the suggested behavior is obtained from a library of predefined behaviors in the assist scenario database, and the predefined behaviors are populated in the assist scenario database over time based on large language models and prior authorizations of the predefined behaviors by a plurality of teleoperators.

8. The method of claim 1, wherein the suggested behavior includes at least one of throttle control, brake control, steering control to maintain lane-keeping, distance control to maintain distance between the autonomous vehicle and other vehicles, overtaking other vehicles on the left, collision avoidance, or merging.

9. The method of claim 1, further comprising:
determining trajectory components to implement the updated trajectory or the authorized behavior; and
executing the updated trajectory or the authorized behavior, including executing the trajectory components at a drive by wire system of the autonomous mobile robot.

10. The method of claim 1, wherein the autonomous mobile robot comprises an autonomous vehicle.

11. The method of claim 1, further comprising:
deploying a second autonomous mobile robot from the autonomous mobile robot;
using an artificial intelligence model on the autonomous mobile robot to control the second autonomous mobile robot; and
relaying, through the autonomous mobile robot, second teleoperator input to the second autonomous mobile robot.

12. The method of claim 11, wherein deploying the second autonomous mobile robot from the autonomous mobile robot comprises deploying the second autonomous mobile robot to traverse at least one of an initial portion of a route or a final portion of the route on which the autonomous mobile robot is not permitted or is unable to traverse.

13. The method of claim 1, further comprising training the assist scenario database using simulated operational scenarios involving control, trajectory, or behavior of the autonomous mobile robot in addition to the teleoperator input.

14. A non-transitory computer-readable storage medium comprising computer-readable instructions executable by a processor to perform or control performance of operations comprising:
receiving autonomous input for an autonomous mobile robot from an assist scenario database, the autonomous input comprising one or both of a suggested trajectory or a suggested behavior;
receiving teleoperator input comprising one or both of a suggested trajectory adjustment or a suggested behavior authorization;
outputting a trajectory signal that depends on both the autonomous input and the teleoperator input, the trajectory signal comprising one or both of an updated trajectory or an authorized behavior; and
storing one or more of the autonomous input, the teleoperator input, the suggested trajectory adjustment, the suggested behavior authorization, or the trajectory signal in the assist scenario database.

15. The non-transitory computer-readable storage medium of claim 14, the operations further comprising:
recalling from the assist scenario database one or both of the teleoperator input or the trajectory signal in a complex driving scenario; and
executing at the autonomous mobile robot the trajectory signal.

16. The non-transitory computer-readable storage medium of claim 14, wherein the autonomous input comprises the suggested behavior and the suggested behavior is automatically triggered based on contextual information.

17. The non-transitory computer-readable storage medium of claim 16, wherein the contextual information includes at least one of a geographic location, a lane location, a hotspot type, a time of day, a season, weather conditions, or a current teleoperator for the autonomous vehicle.

18. The non-transitory computer-readable storage medium of claim 14, wherein the autonomous input comprises the suggested behavior, the suggested behavior is obtained from a library of predefined behaviors in the assist scenario database, and the predefined behaviors are populated in the assist scenario database over time based on large language models and prior authorizations of the predefined behaviors by a plurality of teleoperators.

19. The non-transitory computer-readable storage medium of claim 14, wherein the autonomous mobile robot comprise an autonomous vehicle.

20. The non-transitory computer-readable storage medium of claim 14, the operations further comprising:
deploying a second autonomous mobile robot from the autonomous mobile robot;
using an artificial intelligence model on the autonomous mobile robot to control the second autonomous mobile robot; and
relaying, through the autonomous mobile robot, second teleoperator input to the second autonomous mobile robot.

21. The non-transitory computer-readable storage medium of claim 20, wherein deploying the second autonomous mobile robot from the autonomous mobile robot comprises deploying the second autonomous mobile robot to traverse at least one of an initial portion of a route or a final portion of the route on which the autonomous mobile robot is not permitted or is unable to traverse.
